(19) United States
(12) Patent Application Publication
(10) Pub. No.: US 2013/0144543 A1
(43) Pub. Date: Jun. 6, 2013

(54) Method for Detecting Breakage of Diesel Particulate Filter

(71) Applicant: Byung Hoon AHN, Hwaseong-si (KR)

(72) Inventor: Byung Hoon AHN, Hwaseong-si (KR)

(73) Assignee: Hyundai Motor Company, Seoul (KR)

(21) Appl. No.: 13/553,481

(22) Filed: Jul. 19, 2012

(30) Foreign Application Priority Data
Dec. 5, 2011 (KR) 10-2011-0129254

(51) Int. Cl. G01B 7/00; G06F 19/00

(52) U.S. Cl. 702/38

(57) ABSTRACT

A method for detecting breakage of a diesel particulate filter (DPF) for detecting a tiny breakage of the DPF may include obtaining a learned value of a flow resistance in the DPF when a regeneration of the DPF is terminated, calculating a predicted value of the flow resistance, determining whether the learned value is within a permissible error range of the predicted value, and determining that the DPF is broken if the learned value is not within the permissible error range. The method may further include storing an arithmetic average of the learned value according to a mileage of a vehicle and transforming a relation between the mileage and the learned value to a polynomial expression.

### CROSS-REFERENCE TO RELATED APPLICATION

The present application claims priority of Korean Patent Application Number 10-2011-0129254 filed Dec. 5, 2011, the entire contents of which application is incorporated herein for all purposes by this reference.

### BACKGROUND OF INVENTION

1. Field of Invention

The present invention relates to a method for detecting breakage of a diesel particulate filter. More particularly, the present invention relates to a method for detecting breakage of a diesel particulate filter using monitoring.

2. Description of Related Art

Generally, a diesel particulate filter (DPF) is a filter for removing particulate materials (PM) in exhaust gas of a diesel engine. Recently, the use of diesel engines having excellent output and fuel consumption has been increasing. However, international regulations regarding exhaust gas of diesel engine are being reinforced. Thus, various post-processing devices are mounted in diesel engine vehicles for coping with the international regulations. In addition, the DPF, which is one of post-processing devices mounted in diesel engine vehicles, is extensively used. The DPF collects and filters PM exhausted from a diesel engine. In addition, the DPF repeatedly performs regeneration such that soot is burned by increasing the temperature of the exhaust gas when a predetermined amount of PM is accumulated therein. In the regeneration of the DPF, it is very important for an amount of soot accumulated in the filter is precisely predicted. A method of predicting the amount of soot according to a pressure change between the front and rear end portions of the DPF is often used. Further, it is determined that breakage of the DPF occurs when it is determined that the pressure change between the front and rear end portion of the DPF is higher than a predetermined value through monitoring. However, according to a conventional method for detecting breakage of a DPF, it is possible that the breakage of the DPF is detected only when a substrate in the DPF is completely broken. Therefore, it cannot be detected that efficiency of collecting PM is deteriorated by a tiny breakage of the DPF.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a method for detecting breakage of a diesel particulate filter (DPF) having advantages of detecting a tiny breakage of the DPF.

A method for detecting breakage of a diesel particulate filter (DPF) may include obtaining a learned value of a flow resistance in the DPF when a regeneration of the DPF is terminated, calculating a predicted value of the flow resistance, determining whether the learned value is within a permissible error range of the predicted value, and determining that the DPF is broken if the learned value is not within the permissible error range.

The method may further include storing an arithmetic average of the learned value according to a mileage of a vehicle and transforming a relation between the mileage and the learned value to a polynomial expression.

The predicted value may be calculated by using the polynomial expression.

If the learned value is within the permissible error range, the above steps are reiterated.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWING

FIG. 1 is a flowchart of an exemplary method for detecting breakage of a diesel particulate filter according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

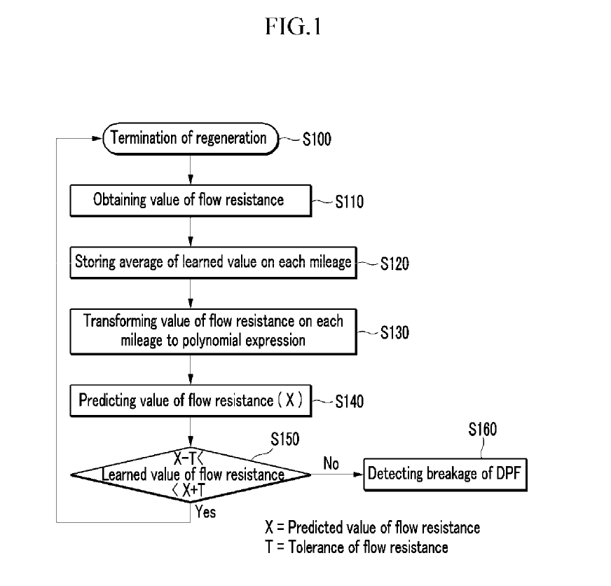

FIG. 1 is a flowchart of a method for detecting breakage of a diesel particulate filter according to various embodiments of the present invention.

As shown in FIG. 1, a method for detecting breakage of a diesel particulate filter (DPF) according to various embodiments of the present invention includes obtaining a learned value of flow resistance in the DPF at step S110 when regeneration of the DPF is terminated at step S100, storing an arithmetic average of the learned value according to mileage of a vehicle at step S120, transforming a relation between the mileage and the learned value to a polynomial expression at step S130, calculating a predicted value of the flow resistance at step S140, determining whether the learned value is within a permissible error range of the predicted value at step S150, and determining that the DPF is broken if the learned value is not within the permissible error range at step S160.

An electronic control unit (ECU) stores a value of flow resistance in the DPF at step S110 when a regeneration of the DPF is terminated at step S100. Herein, the step S110 may include a step in which the ECU determines termination of the regeneration of the DPF. In addition, the stored value of flow resistance becomes a learned value of flow resistance in the DPF. Meanwhile, the flow resistance is a value of pressure change between the front and rear end portions of the DPF divided by exhaust gas amount.

The ECU stores an arithmetic average of the learned value according to the mileage of a vehicle at step S120 if the learned value of flow resistance is obtained. In addition, the ECU transforms a relation between the mileage and the learned value to a polynomial expression at step S130. Herein, the polynomial expression may be a quadratic polynomial.

The ECU calculates the predicted value of the flow resistance at step S140 if the quadratic polynomial is established. That is, the predicted value is calculated by the quadratic polynomial.

The ECU determines whether the learned value is within a permissible error range of the predicted value at step S150 if the predicted value is calculated. Herein, the permissible error may be set by a person of ordinary skill in the art.

The ECU determines that the DPF is broken if the learned value is not within the permissible error range at step S160.

Meanwhile, the method returns to step S110 if the learned value is within the permissible error range.

According to the method for detecting breakage of the DPF, a tiny breakage of the DPF can be detected.

For convenience in explanation and accurate definition in the appended claims, the terms front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for detecting breakage of a diesel particulate filter (DPF), the method comprising:
obtaining a learned value of a flow resistance in the DPF when a regeneration of the DPF is terminated;
calculating a predicted value of the flow resistance;
determining whether the learned value is within a permissible error range of the predicted value; and
determining that the DPF is broken if the learned value is not within the permissible error range.

2. The method of claim 1, further comprising:
storing an arithmetic average of the learned value according to a mileage of a vehicle; and
transforming a relation between the mileage and the learned value to a polynomial expression.

3. The method of claim 2, wherein the predicted value is calculated by using the polynomial expression.

4. The method of claim 1, which is reiterated if the learned value is within the permissible error range.
